(19) United States
(12) Patent Application Publication
(10) Pub. No.: US 2026/0351434 A1
(43) Pub. Date: Nov. 5, 2026

(54) SYSTEM AND METHOD FOR NUCLEAR REACTOR CONTROL

(71) Applicant: HADRON ENERGY, INC., REDWOOD CITY, CA (US)

(72) Inventors: Samuel Gibson, San Francisco, CA (US); Christopher R. Neal, San Francisco, CA (US); Ryan Firpo, San Francisco, CA (US)

(21) Appl. No.: 19/668,427

(22) Filed: May 5, 2026

Related U.S. Application Data
(60) Provisional application No. 63/800,247, filed on May 5, 2025.

(51) Int. Cl. G21D 3/00; G21C 17/032; G21C 17/112; G21D 3/04

(52) U.S. Cl. CPC G21D 3/001; G21C 17/032; G21C 17/112; G21D 3/04

(57) ABSTRACT

Systems, methods, and computer-readable media for controlling operation of a nuclear reactor system using a digital twin model are provided. Operational data is processed to generate a control output for at least one control parameter of the nuclear reactor system.

### CROSS-REFERENCE TO RELATED APPLICATIONS

This application claims the benefit under 35 U.S.C. § 119(e) of U.S. Provisional Patent Application No. 63/800247 filed May 5, 2025, and titled “METHODS AND SYSTEMS FOR MICROREACTOR DESIGN AND CONTROL,” the entirety of which is incorporated herein by reference.

### TECHNICAL FIELD

The present disclosure relates generally to control systems for nuclear reactors.

### BACKGROUND

Reactor systems, including microreactors and other nuclear reactor installations, may be configured to generate thermal energy through controlled fission reactions within a reactor core. The thermal energy produced by the reactor core may be transferred to a working fluid through a coolant system and may be used to generate electrical power, provide process heat, or support other energy applications.

### SUMMARY

The subject matter described herein generally relates to systems, methods, and computer-readable media for controlling operation of a reactor system using a digital twin model. The digital twin model may process operational data received from one or more sensors associated with the reactor system to generate control outputs for adjusting one or more control parameters of the reactor system.

In one aspect, the subject matter described herein relates to a computer-implemented method for controlling operation of a reactor system, the method comprising receiving operational data indicative of an operating state of the reactor system, processing the operational data using a digital twin model to generate a control output for at least one control parameter of the reactor system, and causing adjustment of the at least one control parameter based on the control output.

In another aspect, the subject matter described herein relates to a system for controlling operation of a reactor system, the system comprising at least one sensor configured to provide operational data, one or more processors, a memory storing instructions that cause the one or more processors to process the operational data using a digital twin model to generate a control output, and at least one actuation mechanism configured to implement the control output.

In a further aspect, the subject matter described herein relates to a non-transitory computer-readable medium storing instructions that, when executed by one or more processors, cause the one or more processors to receive operational data, process the operational data using a digital twin model to generate a control output for at least one control parameter, and cause adjustment of the at least one control parameter based on the control output.

These and other aspects of the subject matter described herein will become apparent from the following disclosure. This summary presents illustrative aspects of the subject matter described herein and is not intended to limit the scope of the invention, which is defined by any claims supportable by this disclosure and the equivalents of the embodiments and structures discussed herein.

### BRIEF DESCRIPTION OF THE DRAWINGS

FIG. 1 is a schematic of a nuclear power system.

FIGS. 2A and 2B are perspective views showing one end of a microreactor that can be used in the nuclear power system of FIG. 1. FIG. 2B shows a reactor pressure vessel of the microreactor as transparent so the internal components can be seen.

FIGS. 3A and 3B are perspective views showing the other end of the microreactor shown in FIGS. 2A and 2B. FIG. 3B shows a reactor pressure vessel of the microreactor as transparent so the internal components can be seen.

FIGS. 4A, 4B, and 4C show a microreactor that can be used in the nuclear power system of FIG. 1. FIG. 4A is a perspective partial cutaway view of the microreactor, FIG. 4B is a front partial cutaway view of the microreactor, and FIG. 4C is a side partial cutaway view of the microreactor.

FIG. 5 is a gas-cooled pebble bed reactor vessel assembly that can be used in the nuclear power system of FIG. 1.

FIG. 6 is a schematic depicting a multi-unit configuration of a nuclear power system.

FIG. 7 is a block diagram of a digital twin framework that can be used with the nuclear power system of FIG. 1.

FIG. 8 is a block diagram of a control system that can be used with the nuclear power system of FIG. 1.

FIG. 9 is a block diagram of a model architecture that can be used in the digital twin framework of FIG. 7.

FIG. 10 is a flow diagram of a control-update process that can be used with the control system of FIG. 8.

FIG. 11 is a schematic of a computing system that can be used to implement the digital twin framework of FIG. 7, the control system of FIG. 8, and the model architecture of FIG. 9.

### DETAILED DESCRIPTION OF THE PREFERRED EMBODIMENTS

Microreactor systems may operate under varying conditions and may involve coupled physical processes that influence reactor behavior and system performance. Conventional control approaches may rely on predefined control logic or simplified models that may not fully represent dynamic system behavior under changing operating conditions. Such approaches may not adequately account for real-time operating conditions, system interactions, and applicable operational constraints, which may limit control responsiveness, adaptability, and overall system performance.

To address these and other considerations, the present disclosure relates to systems, methods, and computer-readable media for controlling operation of a reactor system, such as a microreactor system, using a digital twin reactor model, such as a digital twin microreactor model. The disclosed techniques can be implemented in connection with compact nuclear reactor installations configured to provide electrical power, thermal energy, steam, or any combination thereof. A digital twin microreactor model, as described herein, can provide a computational representation of at least a portion of a physical microreactor system and can be used to process operational data indicative of an operating state of the microreactor system, estimate present and projected operating conditions, and generate a control output for adjusting one or more control parameters of the microreactor system.

While the detailed description that follows refers to microreactor systems as illustrative examples, the disclosed techniques are applicable to reactor systems of various scales and configurations, including but not limited to microreactors, small modular reactors, and conventional power reactors. References to “microreactor” throughout the description are provided as non-limiting examples. As used herein, the term “reactor system” encompasses nuclear reactor installations of various thermal outputs, physical footprints, and deployment configurations.

A microreactor system may be organized around a reactor vessel or other containment structure that houses the reactor core and cooperates with one or more reactivity-control components and a coolant system to sustain controlled heat generation and heat removal. Depending on the installation, the heat removed from the core may then be transferred through heat exchangers, steam generators, pumps, valves, manifolds, turbines, generators, electrical distribution components, or other balance-of-plant equipment so that the thermal output of the reactor can be converted or delivered for a desired use. Instrumentation, control, and protection functions may be implemented locally, remotely, or in a distributed architecture, and one or more user interfaces may present operating conditions, alarms, model outputs, and recommended control actions to support monitoring and supervisory control.

Within this overall system, the reactor core may include one or more fuel-bearing regions together with moderator or reflector material, structural support components, coolant passages, and movable or otherwise adjustable reactivity-control elements that cooperate to govern reactor behavior. The coolant system may circulate coolant through or around the core to extract thermal energy and deliver that energy to a heat sink, thermal load, or power-conversion subsystem. When a heat exchanger or steam generator is present, data from the secondary side, such as steam production rate, pressure, temperature, or related process variables, may also be supplied to the digital twin microreactor model because such data can indicate plant demand, heat-removal capability, or overall system performance. These physical arrangements are non-limiting examples, and the disclosed control techniques may be applied to other microreactor configurations.

Operational data may be received from at least one sensor associated with the microreactor system and may characterize both the current operating state of the system and, in some implementations, a recent operating history. For example, the operational data may reflect core neutronics, thermal conditions, coolant-system pressure, radiation levels, steam production, and the positions of reactivity-control components such as control rods. Where the system also includes a secondary heat-transfer loop or a power-conversion subsystem, the operational data may further capture flow conditions, pump states, valve positions, heat-exchanger conditions, turbine or generator conditions, electrical output, actuator statuses, commanded setpoints, and other process variables so that the digital twin can evaluate reactor behavior in the context of overall energy production or heat delivery.

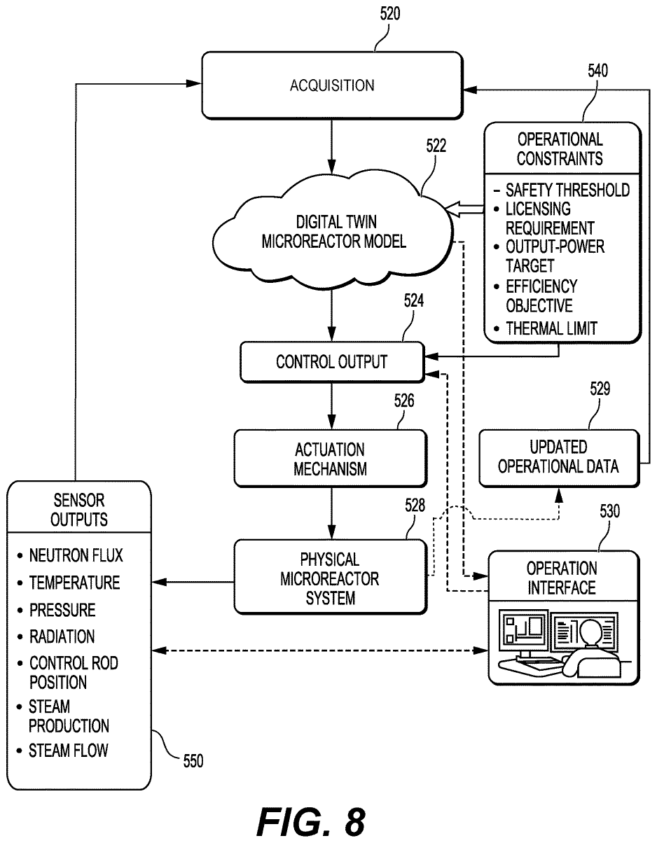

The operational data may be obtained through one or more neutron flux sensors configured to provide neutron flux data, temperature sensors configured to provide temperature data indicative of temperature in a reactor core region or within a coolant system of the nuclear reactor system, pressure sensors configured to provide pressure data indicative of pressure within the coolant system, radiation sensors configured to provide radiation data, steam or flow sensors configured to provide steam production data, control rod position sensors configured to provide control rod position data, or any combination thereof, with the particular sensor arrangement selected according to the reactor configuration and the variables to be monitored. The resulting sensor outputs may be acquired directly by data-acquisition hardware, or they may pass through a plant control system or one or more intermediate processors that perform signal conditioning, time synchronization, filtering, validation, normalization, sensor fusion, or state-estimation operations before the data are provided to the digital twin microreactor model. As a result, the digital twin may operate on raw measurements, derived variables, estimated states, historical time-series data, or any combination thereof. With reference to FIG. 8, the sensor outputs 550 may include neutron flux, temperature, pressure, radiation, steam production, and control rod position data provided by the sensors described herein.

The digital twin microreactor model may represent reactor behavior at one or more levels of abstraction so that the model remains computationally useful while still capturing the phenomena most relevant to control. In some embodiments, the model represents coupled neutronic and thermal-hydraulic behavior, and it may also account for additional effects such as heat transfer within the core or coolant circuit, transient response to control actions, fuel depletion or burn-up, radiation-related quantities, and interactions between the reactor portion of the system and balance-of-plant equipment. The model may be implemented as a single integrated model or as multiple coordinated submodels associated with respective plant subsystems, and those models may be tailored to a particular installed microreactor or instantiated from a reusable framework. By receiving updated operational data on a recurring basis, the model can estimate a current reactor state, project a future reactor state, and produce other control-relevant quantities that may not be directly measurable.

In some embodiments, the digital twin microreactor model includes a reduced-order model (ROM) or a simplified physics-based model. Such a model may provide a lower-complexity computational representation of reactor operation while preserving a degree of physical interpretability and computational speed suitable for online use. A reduced-order model may be derived from higher-fidelity analyses, first-principles formulations, empirical relationships, test data, or any combination thereof. For example, the reduced-order model may represent reactor kinetics, reactivity effects, coolant transport, heat removal, pressure behavior, steam generation, or coupled plant dynamics by means of a lumped-parameter formulation, a state-space formulation, a reduced-basis approximation, a response-surface representation, or another reduced representation suitable for generating control-relevant outputs.

Training or parameterization data for the digital twin microreactor model may be developed from simulated performance data, measured performance data, or a combination of both so that the model reflects both expected and observed reactor behavior. The simulated portion of that dataset may be generated using neutronic, thermal-hydraulic, multiphysics, computational-fluid-dynamics, depletion, transient, safety-analysis, licensing-analysis, or other appropriate modeling tools, and in some implementations data generated by a reduced-order model are used to train or refine a data-driven model. These training datasets may associate measured or simulated input conditions with target state estimates, projected states, predicted performance values, or desired control outputs. Model development and validation may further draw on data from hydraulic test facilities, engineering-scale testbeds, mock reactor systems, physical reactors, initial operational testing, or any combination thereof.

According to various aspects, the digital twin microreactor model may comprise a hybrid model including a reduced-order physics-based model and a machine-learning surrogate. In such implementations, the reduced-order physics-based model may provide state variables, intermediate features, baseline predictions, or physically constrained estimates, and the machine-learning surrogate may map those quantities to a control-relevant output, correct residual error, accelerate evaluation, or otherwise supplement the reduced-order model. In other implementations, the digital twin microreactor model comprises a data-driven machine-learning model trained using microreactor system performance data. The data-driven machine-learning model may comprise a neural network or a regression model, including an ensemble regressor, and may be trained using simulated performance data, measured performance data, ROM-generated data, or any combination thereof.

Model execution may be arranged to support real-time or near-real-time control by embedding the digital twin within a framework that integrates data handling, computation, validation, and user interaction. In particular, the framework may combine data-integration functionality, data storage, real-time computing resources, training and validation resources, and one or more graphical or operator-facing interfaces so that the same environment can support both model development and operational use. The inference cadence may be selected to match the dynamics of the controlled subsystem, and the framework may therefore support offline training and validation, online inference, online recalibration, or staged deployment in which a model is first trained with simulated data, then validated against testbed or reactor data, and thereafter used in an advisory, supervisory, or closed-loop mode. In some embodiments, newly acquired performance data are used to retrain or incrementally update the model so that it remains representative of the physical microreactor system over time.

One or more processors may use the operational data and the digital twin microreactor model to generate a control output for at least one control parameter of the microreactor system. Depending on the control strategy and the plant subsystem being adjusted, that control output may take the form of a single command, a setpoint, a parameter update, a rate adjustment, a sequence of commands, a recommended operating window, or a coordinated vector of adjustments. The controlled parameter may include, for example, control rod position, reactor coolant pump operating state, or coolant flow-control device state, and the resulting output may therefore specify a control rod insertion value or movement command, a pump state or speed, a valve position, a bypass setting, or another flow-regulating adjustment associated with the coolant system. In some embodiments, the operational data supplied to the digital twin microreactor model correspond to measured states of physical reactor subsystems, including neutron flux, control rod position, coolant temperature, coolant pressure, pump state, valve position, steam-production conditions, and feedwater conditions, and the control output corresponds to a command for one or more physical actuators of the reactor system. For example, the control output may command a control-rod drive mechanism, a primary-coolant pump controller, a valve actuator, a pressurizer heater, a pressurizer spray assembly, a gas circulator or blower, or a feedwater pump, depending on the reactor configuration. For a deployed reactor installation, the digital twin microreactor model may be parameterized using design data, test data, and initial operational data from the physical microreactor system and may thereafter be recalibrated using updated operational data.

Generating the control output may comprise predictive control, feedback control, or both. In predictive control implementations, the digital twin microreactor model may project one or more future reactor states over a control horizon based on a current reactor state and one or more candidate control actions, and may select a control output based on the projected performance of the microreactor system. In feedback control implementations, the control output may be updated based on a deviation between an observed operating state and a desired operating state. In combined implementations, a predictive control component may anticipate future excursions or constraint interactions while a feedback control component compensates for disturbances, model mismatch, or sensor noise, thereby supporting continuous or near real time adjustment of one or more control parameters. Control-output generation may occur continuously, periodically, or in response to one or more trigger conditions.

The control output may be generated subject to one or more operational constraints so that the selected control action remains aligned with safety, regulatory, and performance requirements. Those constraints may include, for example, safety thresholds, licensing requirements, output-power targets, efficiency objectives, and thermal limits, each of which may be expressed in terms of monitored quantities such as neutron flux, temperature, pressure, radiation, actuator position, heat utilization, pump usage, actuator wear, or permissible operating envelopes. In some implementations, certain constraints are enforced as hard constraints while other objectives are treated as soft constraints or optimization goals. Where multiple constraints or objectives apply simultaneously, the processors may use a rule set, optimization routine, weighting scheme, priority hierarchy, or other decision logic to determine a control output that balances the relevant considerations.

At least one actuation mechanism may implement the control output by physically adjusting the selected control parameter of the microreactor system. For example, the actuation mechanism may take the form of a control rod drive mechanism, a coolant pump controller, a variable-speed drive, a valve actuator, or a hydraulic, pneumatic, electric, piezoelectric, mechanical, or combined actuation arrangement, depending on the plant architecture and the parameter being controlled. In some implementations, the control output is applied automatically, whereas in other implementations it is first presented through an operation interface or other user interface so that an operator may review, confirm, modify, or override the proposed action. Once the action is implemented, updated operational data may be returned to the digital twin microreactor model, thereby supporting repeated or continuous refinement of the control output.

The disclosed control architecture may be used during steady-state operation, startup, shutdown, load following, thermal ramping, transient recovery, or other operating modes. In certain implementations, the digital twin microreactor model is used to maintain a target output while keeping measured or predicted operating conditions within one or more permissible ranges. In other implementations, the model is used to reduce oscillations, improve efficiency, support operator decision-making, compensate for changing external demand, or coordinate reactor operation with downstream equipment such as a heat exchanger, a steam-production subsystem, or a power-conversion subsystem. The digital twin microreactor model may also be used to estimate margins to one or more operational constraints and to select control actions that preserve those margins.

In some embodiments, the digital twin-based control system operates in conjunction with other plant monitoring, control, or protection systems. For example, the control system described herein may provide supervisory or advanced control functionality while one or more separate protective systems, interlocks, or trip logics remain available to perform independent safeguard functions. The digital twin microreactor model may further be configured to detect or accommodate missing data, inconsistent sensor readings, communication latency, or model-confidence conditions, and may respond by selecting a fallback control mode, reducing the scope of automated action, generating an operator advisory, or otherwise adapting system behavior in a manner suitable for the implementation.

The functions described herein may be carried out by one or more processors executing instructions stored in memory, with the processing resources located on-site, at a remote facility, or across a distributed computing architecture that combines local control hardware and remote computing resources. A computing system suitable for this purpose may include processors, memory such as read-only memory and random-access memory, storage devices that hold program modules, input and output devices, and communication interfaces coupled through one or more buses or other interconnects. These program modules may cooperate to acquire and preprocess data, execute the digital twin model, perform training and validation, generate control outputs, interface with actuators, present information through a user interface, and maintain data logs, thereby allowing the disclosed control architecture to operate as an integrated computing environment.

A non-transitory computer-readable medium may store instructions that, when executed by one or more processors, cause the one or more processors to receive operational data for the microreactor system, process the operational data using the digital twin microreactor model to generate a control output for at least one control parameter of the microreactor system, and cause adjustment of the at least one control parameter based on the control output. The instructions may further cause the processors to update the control output in real time or near real time in response to updated operational data, to generate the control output using predictive control, feedback control, or both, and to satisfy one or more operational constraints, including a safety threshold, a licensing requirement, an output-power target, an efficiency objective, or a thermal limit.

Accordingly, the disclosed systems and methods provide a flexible framework in which operational data from a physical microreactor system can be integrated with a digital twin microreactor model to support state estimation, prediction, and control. The particular arrangement of sensors, processors, model components, training workflows, control algorithms, actuation mechanisms, and operator interfaces may vary from implementation to implementation. Likewise, functions described in connection with one embodiment may be combined, separated, reordered, or omitted in other embodiments, provided that the operational data are processed using a digital twin microreactor model to generate a control output for at least one control parameter of the microreactor system. These functions may be embodied in a method, in a control system comprising sensors, processors, memory, and actuation hardware, or in a non-transitory computer-readable medium storing instructions for performing the disclosed operations.

The accompanying figures depict exemplary embodiments of microreactor systems, associated plant hardware, deployment arrangements, digital twin training and control architectures, and computing implementations that may be used alone or in combination. The illustrated embodiments are provided for purposes of explanation and may be varied in geometry, scale, arrangement, degree of integration, operational mode, and implementation detail while remaining within the scope of the present disclosure.

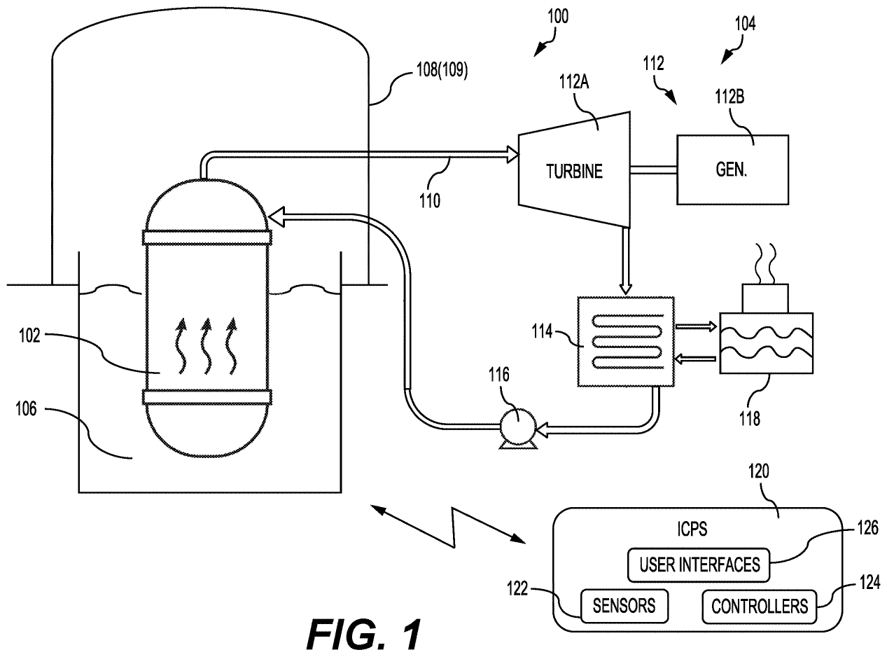

FIG. 1 is a schematic of a nuclear power system 100. The nuclear power system 100 includes a nuclear reactor, which as depicted in FIG. 1 can be a microreactor 102. The microreactor 102 is a compact, integral nuclear reactor. When operating, the microreactor 102 can produce thermal energy for various processes, such as electrical power generation or industrial heat applications.

The nuclear power system 100 includes a power-conversion region that is thermally coupled to the microreactor 102. The nuclear power system 100 includes a secondary-coolant loop 110 that circulates a secondary coolant between the microreactor 102 and a turbine-generator set 112. Within the microreactor 102, heat can be transferred to the secondary coolant in a steam generator, converting the secondary coolant to steam. The steam flows through the secondary-coolant loop 110 to the turbine-generator set 112. The turbine-generator set 112 includes a turbine 112A mechanically coupled to a generator 112B. The steam expands through the turbine 112A, causing the turbine 112A to rotate and drive the generator 112B to produce electrical power. Exhaust from the turbine 112A is directed to a condenser 114, where the secondary coolant is condensed to liquid form. The condenser 114 can be thermally coupled to a tertiary cooling system 118 that removes residual heat from the secondary coolant and rejects the residual heat to a heat sink, such as the environment through a cooling tower or natural heat sink. A feedwater pump 116 returns the condensed secondary coolant to the microreactor 102, completing the closed circuit of the secondary-coolant loop 110.

The configuration shown in FIG. 1 is one example of a power-conversion arrangement. In other embodiments, the thermal energy can be transferred through an intermediate heat transfer loop disposed between the primary coolant and the secondary system. In still other embodiments, the primary coolant can be used directly for power conversion or process heat without a separate secondary system. The power-conversion region 104 can include different or additional components suited to the intended application.

The microreactor 102 can be disposed within a flooded suppression pool 106 in which the microreactor 102 is at least partially submerged. The flooded suppression pool 106 can provide an integrated ultimate heat sink and radiation shield, as well as a secondary physical barrier around the microreactor 102. A reactor building 108 can enclose a reactor bay, provide environmental protection, and support maintenance functions such as fuel handling and component replacement. In some cases, the reactor building 108 can be constructed as or can include a containment structure 109 that provides additional confinement for radioactive materials. The nuclear power system 100 further includes an Instrumentation, Control, and Protection Subsystem (ICPS) 120, schematically represented in FIG. 1. The ICPS 120 can monitor and control operation of the microreactor 102 and the power-conversion region. The ICPS 120 can include one or more sensors 122 disposed to measure parameters such as coolant temperature, pressure, flow rate, neutron flux, and power output within the microreactor 102 and associated systems. Signals from the sensors 122 can be transmitted to one or more controllers 124 configured to process the data and to regulate system components. User interfaces 126 can provide real-time display of reactor and system parameters and allow manual input or override of automated functions.

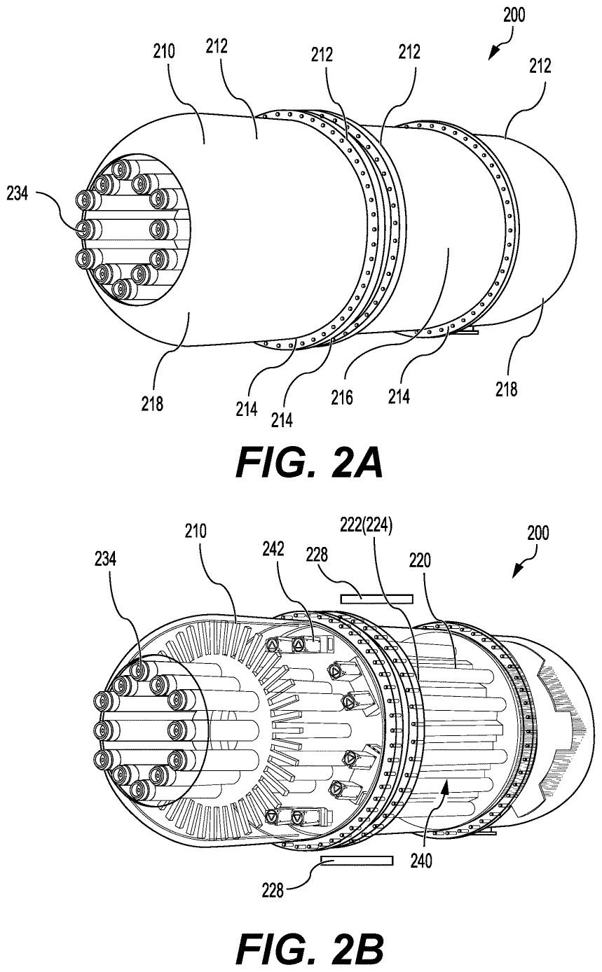

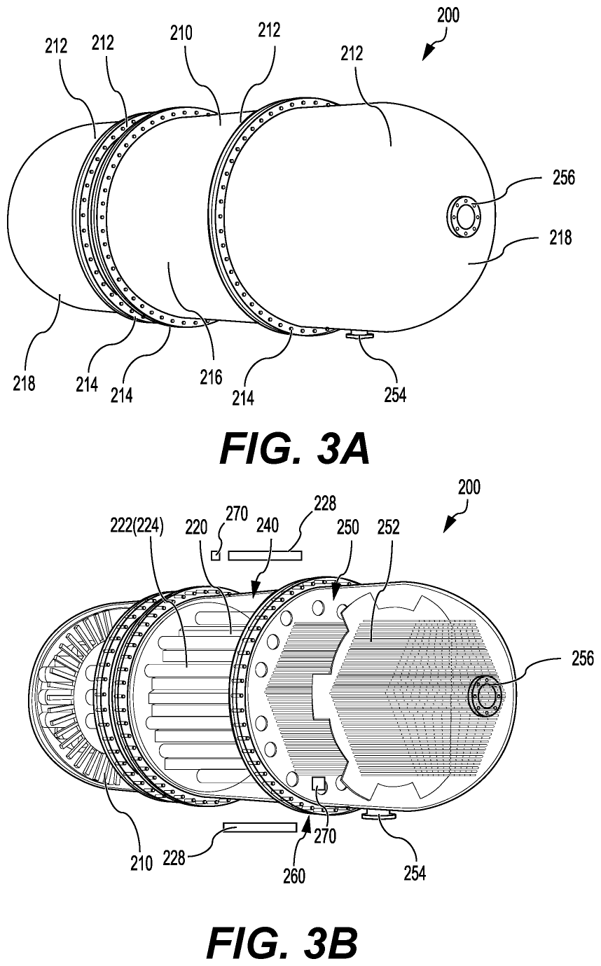

FIGS. 2A and 2B are perspective views showing one end of a microreactor 200 that can be used in the nuclear power system 100 of FIG. 1. FIGS. 3A and 3B are perspective views showing the other end of the microreactor 200. FIGS. 2B and 3B show a reactor pressure vessel (RPV) 210 of the microreactor 200 as transparent so the internal components can be seen.

The microreactor 200 shown in FIGS. 2A to 3B is an integral, modular reactor design in which the primary systems are contained within a single RPV 210. The RPV 210 can include a plurality of vessel segments 212 that can be connected to each other through circumferential flanges 214. The RPV 210 can have a central cylindrical section 216 and hemispherical ends 218. The vessel segments 212 may be connected through the circumferential flanges 214, which may be formed by welded joints, bolted flanges, clamped collars, or other attachment structures. The hemispherical ends 218 enclose each axial end of the RPV 210, distributing pressure loads uniformly and minimizing localized stress concentrations.

A reactor core 220 is positioned within one of the vessel segments 212 of the RPV 210. The reactor core 220 includes a plurality of fuel assemblies 222 arranged in a compact lattice to define an active core region. Each fuel assembly 222 can include multiple fuel elements 224 containing enriched uranium fuel. The fuel assemblies 222 are supported and aligned within the vessel by internal core support structures. The fuel assemblies 222 are surrounded by one or more neutron reflectors 228 to improve neutron economy within the compact geometry of the microreactor 200.

Reactivity within the reactor core 220 can be controlled through a set of control rods 232 that are insertable into the core. The control rods 232 are operated by corresponding control-rod drive mechanisms 234. The control-rod drive mechanisms 234 can move the control rods 232 to adjust reactor power during operation. The control-rod drive mechanisms 234 can also rapidly insert the control rods 232 to achieve a shutdown condition.

A primary-coolant circuit 240 circulates within the RPV 210 to transfer thermal energy generated in the reactor core 220 to an integral steam generator 250. A primary coolant circulates through the primary-coolant circuit 240. The primary coolant can be light water. Light water can function as both the primary coolant and a neutron moderator within the microreactor 200. The primary coolant flows through a plurality of core flow passages within the reactor core 220. Heat is extracted from the heated primary coolant and transferred across a network of heat-transfer structures 252 to the secondary-coolant loop 110 (FIG. 1) of the nuclear power system 100 (FIG. 1). The cooled primary coolant then returns to one end of the reactor core 220, such as through passages positioned around the periphery of the reactor core 220 to complete the internal flow path. One or more primary-coolant pumps 242 can be disposed within the RPV 210 to circulate the primary coolant through this closed circuit during normal operation.

The steam generator 250 is fluidly connected to the primary-coolant circuit 240 to receive the primary coolant. The steam generator 250 transfers heat from the primary coolant to a secondary coolant to generate steam. The steam generator 250 includes an array of heat-transfer structures 252. The heat-transfer structures 252 may include tubes, rods, pins, channels, or heat pipes. The secondary coolant can enter the steam generator 250 through a secondary coolant inlet 254. The secondary coolant can exit as heated steam through a secondary coolant outlet 256, thereby completing the heat exchange between the primary and secondary systems.

A pressurizer 260 can be located within the RPV 210. The pressurizer 260 defines a pressure-control volume within the RPV 210 and primary-coolant circuit 240. The pressurizer 260 maintains the pressure of the primary coolant in a liquid phase under operating temperature and pressure conditions. The integral placement of the pressurizer 260 within the RPV 210 eliminates external pressure-control vessels and associated piping.

Additional features can be incorporated within the RPV 210 to support reactor monitoring, safety, and maintenance functions. These may include in-vessel instrumentation sensors 270 positioned to measure coolant temperature, pressure, flow rate, and neutron flux. The microreactor 200 may also include structural supports and primary system piping. The reactor core 220 and the steam generator 250 may be permanently integrated, or may be configured as removable and interchangeable assemblies. This configuration allows different operating envelopes, fuel forms, instrumentation packages, or control strategies to be implemented without redesigning the entire microreactor 200.

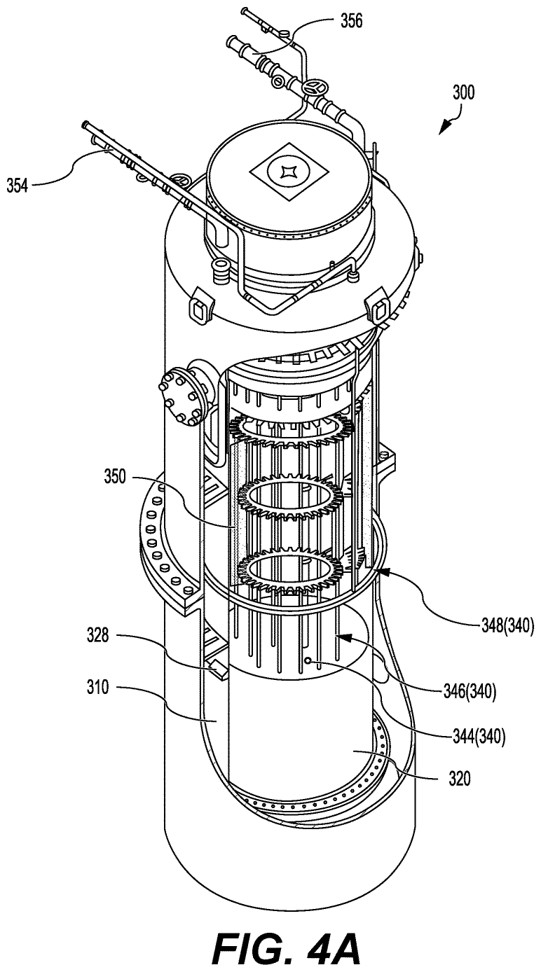

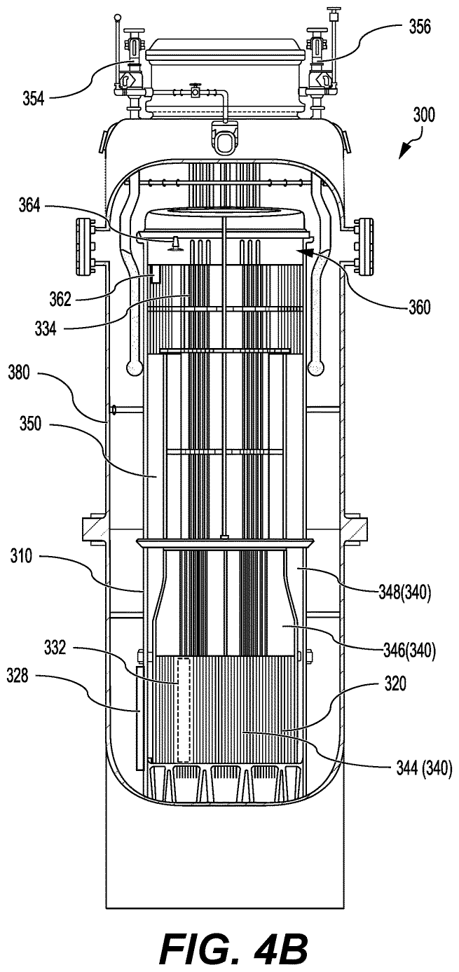

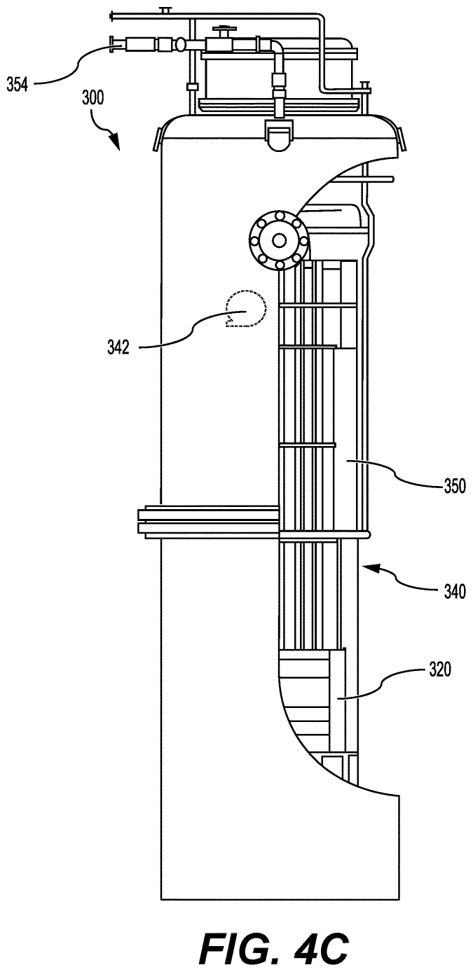

FIGS. 4A, 4B, and 4C show another microreactor 300 that may be used as the microreactor 102 in the nuclear power system 100 shown in FIG. 1. FIG. 4A is a perspective partial cutaway view of the microreactor 300. FIG. 4B is a front partial cutaway view of the microreactor 300. FIG. 4C is a side partial cutaway view of the microreactor 300. The microreactor 300 shown in FIGS. 4A to 4C is similar to the microreactor 200 discussed above with reference to FIGS. 2A to 3B. In FIGS. 4A to 4C, 300-series reference numerals are used for the various components, and the 300-series reference numerals identify features that are the same as or similar to the features identified by 200-series reference numerals in FIGS. 2A to 3B. Accordingly, the detailed description of such components may be omitted, and the details of the systems and components discussed above can also apply to the microreactor 300. In a similar way, features and components of the microreactor 300 discussed below can also apply to the microreactor 200.

The microreactor 300 includes a reactor pressure vessel (RPV) 310 that houses the major reactor systems. The RPV 310 houses a reactor core 320, a steam generator 350, a pressurizer 360, and a primary-coolant circuit 340. The reactor core 320 may be surrounded by one or more neutron reflectors 328. Reactivity within the core may be adjusted through one or more control rods 332 operated by corresponding control-rod drive mechanisms 334.

The primary-coolant circuit 340 in this microreactor 300 is a primary-coolant loop. The primary-coolant loop includes one or more primary-coolant pumps 342, core flow passages 344, riser passages 348, and downcomer passages 346. These passages establish vertical coolant flow between the lower and upper regions of the vessel. During operation, thermal energy generated within the reactor core 320 is transferred to a primary coolant as it passes through the fuel assemblies 322 and core flow passages 344. The heated primary coolant increases in temperature and reduces in density. The heated coolant rises through the riser passages 348 toward the upper portion of the RPV 310. The heated coolant transfers heat to the steam generator 350. The steam generator 350 receives a secondary coolant through a secondary coolant inlet 354. The steam generator 350 discharges heated steam through a secondary coolant outlet 356. The cooled primary coolant flows downward through the downcomer passages 346 around the periphery of the core region. This completes the circulation path. The primary-coolant pumps 342 circulate the primary coolant through the primary-coolant circuit 340. Alternatively, in some embodiments, the primary-coolant pumps 342 may be omitted. In such embodiments, the microreactor 300 may operate in a natural-circulation configuration. In a natural-circulation configuration, primary coolant motion is driven by density differences between the heated coolant rising from the reactor core 320 and the cooled coolant descending from the steam generator 350.

The pressurizer 360 is located in an upper region of the RPV 310. The pressurizer 360 defines a pressure-control volume that maintains the primary coolant at a pressure sufficient to prevent boiling during normal operation. One or more pressurizer heaters 362 may raise coolant temperature within the pressurizer 360 when system pressure is to be increased. One or more pressurizer spray assemblies 364 may introduce cooler primary coolant into the vapor region to condense vapor and thereby reduce pressure. The pressurizer 360, the pressurizer heaters 362, and the pressurizer spray assemblies 364 are located entirely within the RPV 310. This arrangement eliminates external pressure-control vessels and associated piping.

The RPV 310 may be surrounded by a containment structure, such as a containment vessel 380. The containment vessel 380 can be a metal vessel that surrounds the RPV 310. The containment vessel 380 may be positioned coaxially with the RPV 310 and radially spaced outward from an exterior surface of the RPV 310 to define an annular gap therebetween. The containment vessel 380 and the RPV 310 can be disposed together within the flooded suppression pool 106 (FIG. 1). The containment vessel 380 is configured to contain radioactive materials in the event of an abnormal operating condition. The containment vessel 380 can be fabricated from high-strength, corrosion-resistant steel or other reactor-grade materials suitable for high-pressure and high-temperature environments. Unlike the large reinforced concrete containment buildings used in conventional nuclear power plants, the containment vessel 380 is a compact, transportable metal structure that closely conforms to the exterior of the RPV 310. The containment vessel 380 serves as a secondary pressure boundary. The containment vessel 380 provides mechanical protection and localized radiation shielding. The annular gap permits passive heat transfer from the RPV 310 to external cooling systems. The annular gap can also serve as a structural interface for the flooded suppression pool or other external containment features.

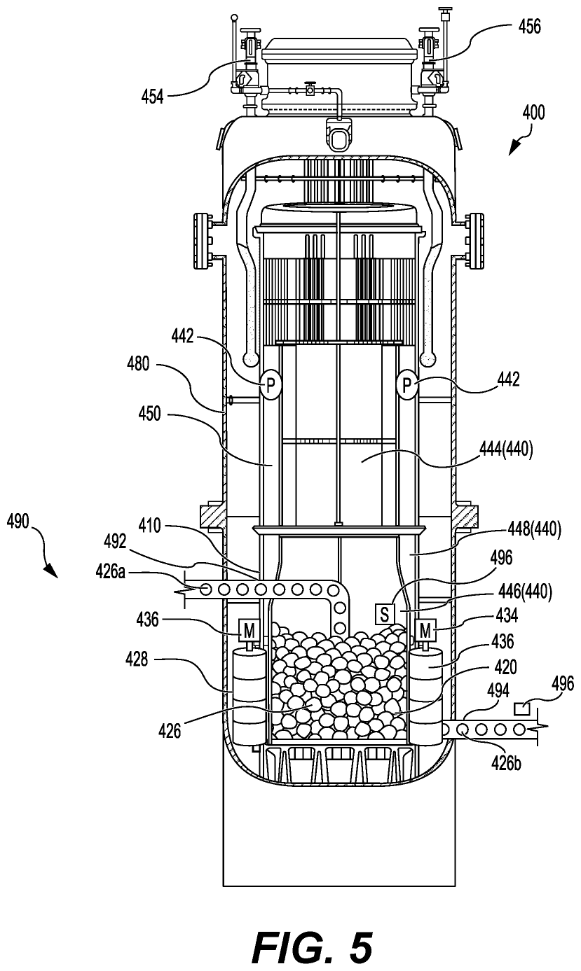

FIG. 5 shows a nuclear reactor system 400 configured as a pebble bed reactor that can be used in the nuclear power system 100 of FIG. 1. FIG. 5 is a cross-sectional view of the nuclear reactor system 400. In FIGS. 5, 400-series reference numerals are used for the various components, and the 400-series reference numerals identify features that are the same as or similar to the features identified by 200-series or 300-series reference numerals in FIGS. 2A to 4C. Accordingly, the detailed description of such components may be omitted, and the details of the systems and components discussed above can also apply to the nuclear reactor system 400. In a similar way, features and components of the nuclear reactor system 400 discussed below can also apply to the microreactors 200 and 300.

The nuclear reactor system 400 includes a core region 420 in a lower portion of the vessel, where a plurality of discrete fuel pebbles 426 are arranged to form the heat-generating reactor core. The fuel pebbles 426 may be graphite spheres containing TRISO (tristructural isotropic) fuel particles, in which fissile material is encapsulated within multiple protective layers of pyrolytic carbon and silicon carbide. The graphite matrix of the fuel pebbles 426 serves as the neutron moderator, slowing fast neutrons to thermal energies to sustain the fission chain reaction. The fuel pebbles 426 may be arranged in various configurations within the core region 420. Suitable configurations include layered arrangements, structured lattices, or containment within baskets, cartridges, or porous supports. In some embodiments, the fuel pebbles 426 may be retained by containment structures, screens, grids, or perforated supports. In other embodiments, the fuel pebbles 426 may be partially mobile or repositionable during startup, shutdown, or maintenance. The size distribution, composition, enrichment, coating, and surface properties of the fuel pebbles 426 may vary. These properties may be selected to influence reactivity, heat transfer, moderation, or structural behavior.

The nuclear reactor system 400 may include a fuel handling system 490 that enables continuous online refueling without requiring reactor shutdown. The fuel handling system 490 includes a fuel loading line 492 positioned at or near the top of the core region 420 through which introduced fuel pebbles 426a enter the core 420. After being introduced through the fuel loading line 492, the fuel pebbles 426 move downward through the core 420 under gravity. At the bottom of the core 420, discharged fuel pebbles 426b exit through a fuel discharge line 494. A sensor 496 associated with the fuel discharge line 494 measures the burnup of each discharged fuel pebble 426b to determine whether the pebble should be recirculated back to the fuel loading line 492 for additional passes through the core 420 or directed to spent fuel storage. This continuous flow-through fuel cycle allows the reactor to operate without shutdown for refueling and enables continuous adjustment of core reactivity over time.

The nuclear reactor system 400 includes a primary-coolant circuit 440 that circulates a primary coolant through the core region 420 to remove thermal energy generated by the fuel pebbles 426. The primary coolant in the nuclear reactor system 400 may be a gas. Suitable gas coolants include helium, carbon dioxide, or nitrogen. The primary coolant flows through interstitial passages between the fuel pebbles 426 to remove heat from the core region 420. The heated gas coolant rises through riser passages 446 toward an upper portion of the vessel. The heated gas coolant may then transfer thermal energy to a steam generator 450 or other heat exchanger. The cooled gas coolant descends through downcomer passages 448 around the periphery of the core region 420 to complete the circulation path. One or more primary-coolant pumps 442 may be provided to drive the gas coolant through the primary-coolant circuit 440. In this embodiment, the primary-coolant pumps 442 may comprise gas circulators or blowers.

The nuclear reactor system 400 may incorporate monitoring features configured to determine whether fuel pebbles 426 are present, absent, properly distributed, or accumulating in unintended regions within the core region 420 or other portions of the vessel. One or more sensors 496 positioned along the vessel, the core region 420, or associated flow passages (e.g., the fuel discharge line 494) may detect pebble-related conditions by observing radiation signatures, neutron flux distribution, temperature gradients, acoustic signals, vibration signatures, optical responses, capacitance, inductance, pressure drop, flow characteristics, or combinations thereof. In some embodiments, the system may be configured to detect residual or uncleared fuel pebbles 426 that remain within the core region 420, within lower vessel regions, or within flow passages after an intended removal or redistribution operation. Differential pressure measurements, flow impedance, or acoustic signatures may indicate obstruction or accumulation of fuel pebbles 426 in regions that are intended to be empty or cleared. Detection of such conditions may trigger automated or semi-automated corrective sequences, which may include controlled gas flow through the vessel to entrain or reposition fuel pebbles 426, mechanical agitation, pulsed flow, or pressure variations to assist in clearing fuel pebbles 426 from specific regions.

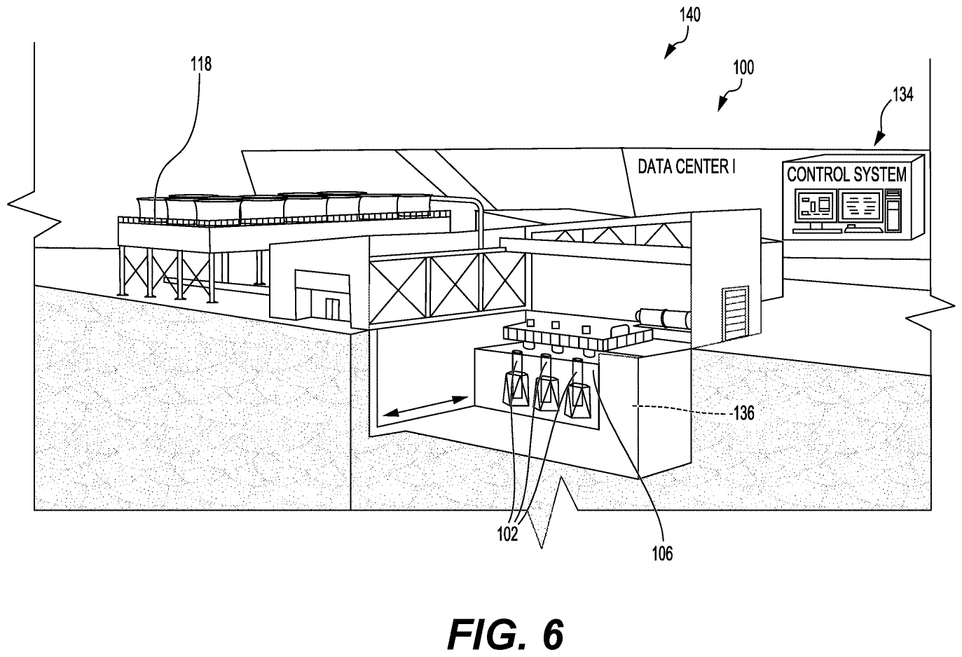

FIG. 6 illustrates an exemplary multi-unit configuration 140 in which a nuclear power system 100 is integrated with site infrastructure. In the illustrated arrangement, a microreactor 102 is positioned within a flooded suppression pool 106. A tertiary cooling system 118 is thermally coupled to the microreactor 102. Power-output lines or facility utilities may distribute electrical or thermal energy to the surrounding site. The multi-unit configuration 140 may further include a monitoring/control station 134. A communication or monitoring/control link 136 may connect the monitoring/control station 134 to the microreactor 102 and associated equipment.

The multi-unit configuration 140 of FIG. 6 may be implemented in connection with a data center, desalination facility, district-heating operation, industrial facility, research station, defense installation, or other site requiring electrical energy, thermal energy, or both. The multi-unit configuration 140 may also be installed at remote, off-grid, or temporary sites where conventional large-scale power infrastructure is unavailable. The modular construction of the nuclear power system 100 may facilitate transportation, assembly, and removal using standard over-the-road or marine equipment. Factory-assembled modules may be transported and interconnected on site to form one or more nuclear power systems supplying a common electrical or thermal load.

The multi-unit configuration 140 may include a plurality of microreactors 102 located within a common flooded suppression pool 106. Each microreactor 102 may be at least partially submerged in the water of the flooded suppression pool 106. Each microreactor 102 may be coupled to associated secondary side components, such as a corresponding secondary-coolant loop 110 (FIG. 1) and turbine-generator set 112 (FIG. 1). The generators 112B (FIG. 1) may be connected individually or collectively to one or more electrical buses to deliver combined electrical output or to provide independent power channels. The arrangement may allow individual microreactors 102 to be added, removed, or serviced without interrupting operation of the other units, providing scalability and continuous power generation.

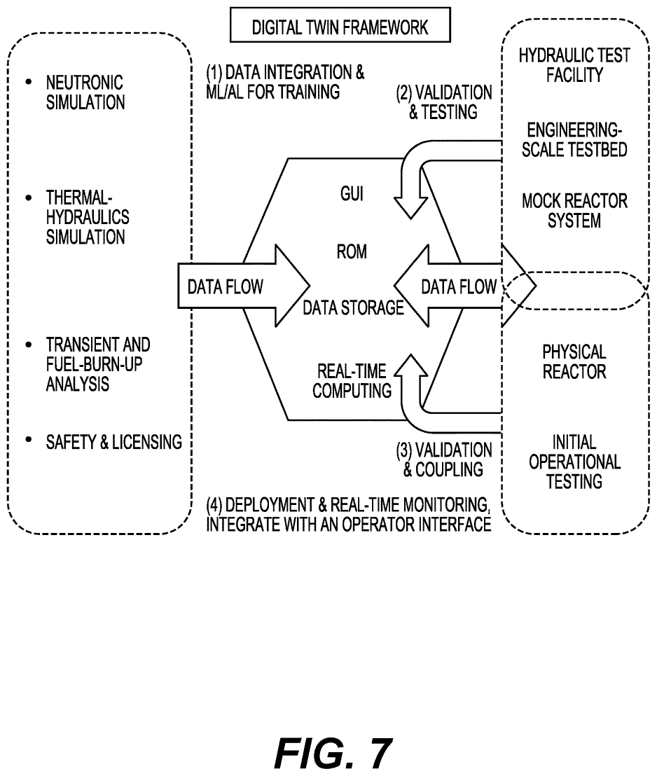

The monitoring/control station 134 is communicatively coupled to the nuclear power system 100, including the microreactors 102. The communication or monitoring/control link 136 connects the monitoring/control station 134 to the ICPS 120, the sensors 122, and the controllers 124 associated with the microreactors 102. The sensors 122 may include temperature sensors, pressure sensors, radiation sensors, and neutron flux sensors to monitor reactor conditions. The controllers 124 may include automated control systems configured to regulate reactor power levels, coolant flow, and overall reactor operations. The ICPS 120 may incorporate protection logic that automatically initiates shutdown procedures when monitored parameters exceed predetermined limits. The monitoring/control station 134 may receive operational data from the sensors 122 associated with the microreactors 102. The monitoring/control station 134 may implement or coordinate with the digital twin framework described with respect to FIGS. 7-10 to process operational data and generate control outputs. The monitoring/control station 134 may provide local monitoring and control. In other embodiments, the monitoring/control station 134 may operate as a supervisory node interconnected with remote operator stations, fleet-control software, or autonomous-control logic. The communication or monitoring/control link 136 may represent wired or wireless communication, optical communication, redundant secure networking, or another control and telemetry path. User interaction may occur locally, remotely, or in a hybrid arrangement that may include manual approval, advisory prompts, automated control recommendations, or direct closed-loop implementation. The nuclear power system 100 may include safety systems such as an emergency core cooling system (ECCS) configured to deliver cooling water to the reactor core during an emergency, passive safety systems that use natural circulation and gravity to cool the core without requiring external power, and a backup power system including diesel generators, batteries, or both.

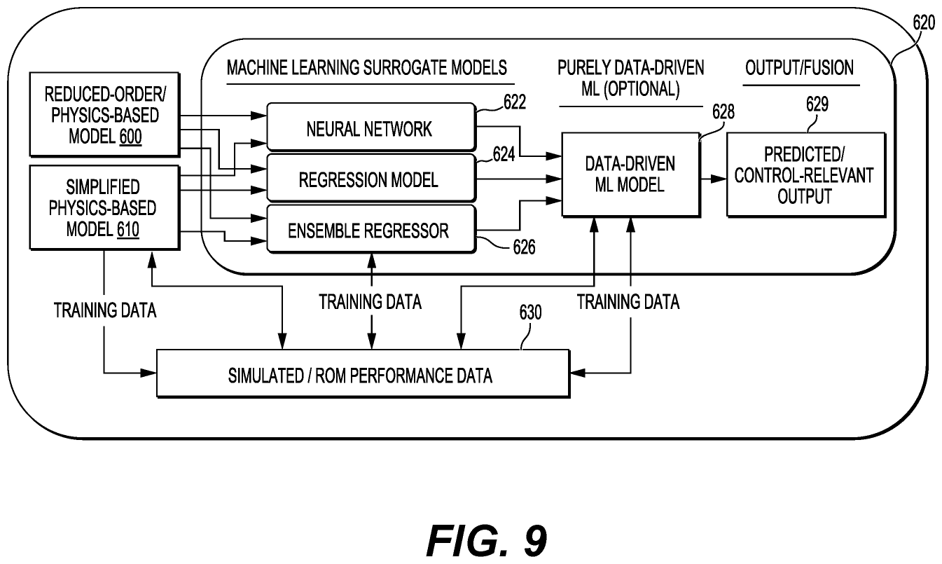

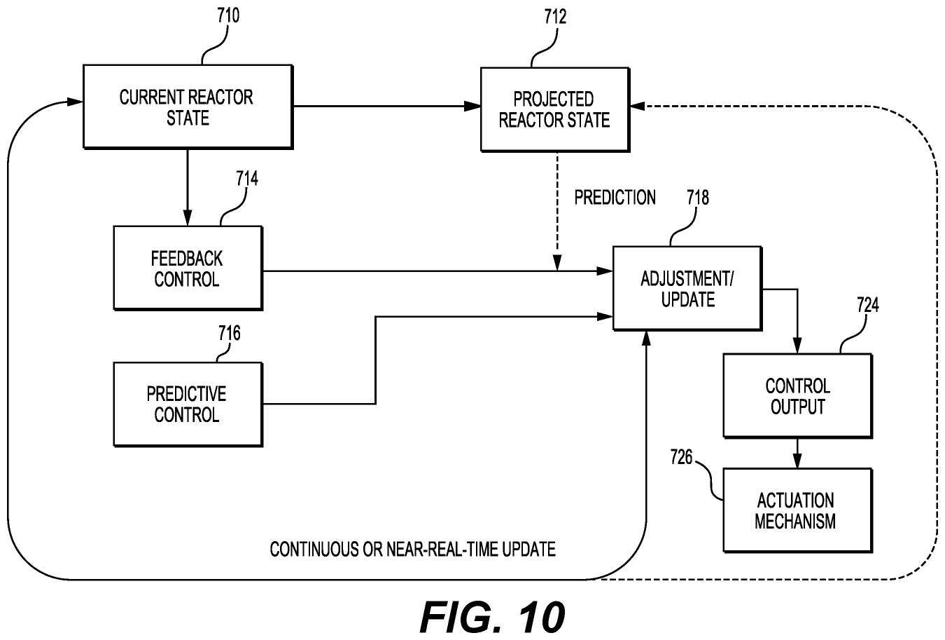

To support these monitoring and control functions, the monitoring/control station 134 may implement or coordinate with a digital twin framework such as that described with respect to FIGS. 7-10. FIG. 7 illustrates development, training, validation, deployment, and refinement of a digital twin microreactor model. FIG. 8 illustrates deployment of the digital twin microreactor model 522 as a virtual counterpart of the physical microreactor system for simulation, prediction, testing, monitoring, and control. FIG. 9 illustrates an exemplary model architecture that may implement the digital twin microreactor model 522. FIG. 10 illustrates an exemplary control-update process in which operational data are used to update projected reactor states and revise control actions during operation

FIG. 7 illustrates an exemplary digital twin framework that supports development, training, validation, deployment, and monitoring of the digital twin microreactor model 522 (FIG. 8). The framework may receive data flow from one or more sources of simulated performance data, including: neutronic simulation, thermal-hydraulics simulation, transient and fuel-burn-up analysis, and safety or licensing analysis. The framework may include internal functional blocks that support data handling and model execution, including: a graphical user interface, a reduced-order model (ROM), data storage, and real-time computing resources. The framework may further exchange data with one or more validation environments, including: a hydraulic test facility, an engineering-scale testbed, a mock reactor system, a physical reactor, and initial operational testing.

Neutronic simulation data may be generated using Monte Carlo neutron transport codes such as OpenMC, MCNP, or Serpent. These tools may model neutron flux distributions, reaction rates, criticality, and other neutronic quantities with high accuracy by tracking individual neutron histories through the reactor geometry. Thermal-hydraulics simulation data may be generated using multi-physics simulation models, computational fluid dynamics (CFD) models, finite element analysis (FEA) models, or combinations thereof. Such tools may characterize coolant flow patterns, heat transfer coefficients, temperature distributions, and pressure behavior within the reactor and associated systems. Fuel burn-up and depletion data may be generated using tools from the ORIGEN family, including ORIGEN, ORIGEN-S, ORIGAMI, OBIWAN, OPUS, ARP, or combinations thereof. These tools may track changes in fuel composition, fission product accumulation, and actinide transmutation over the operating life of the reactor. Safety and licensing analysis data may be generated using system-level thermal-hydraulic codes such as RELAP5, TRACE, or combinations thereof. Such tools may simulate transient scenarios, accident conditions, and system responses relevant to regulatory compliance and safety evaluation.

The digital twin framework of FIG. 7 organizes the activities of model development, training, validation, deployment, and monitoring into a coordinated workflow. Simulated performance data may be received from neutronic simulation tools that characterize neutron behavior within the reactor core. Thermal-hydraulics simulation may provide representations of coolant flow and heat transfer. Transient analysis may capture time-dependent system responses to changing conditions. Fuel-burn-up analysis may track changes in fuel composition over the operating life of the reactor. Safety or licensing analysis may generate data relevant to regulatory requirements and operational boundaries. The framework may process this information through internal functions that support model execution and user interaction. A graphical user interface may present model outputs and accept user inputs. A reduced-order model may generate computationally efficient predictions of reactor behavior. Data storage may maintain records of model inputs, outputs, and operational history. Real-time computing resources may enable model execution at cadences suitable for online monitoring and control. The framework may also exchange data with validation environments so that model behavior can be compared against progressively more representative physical conditions.

The workflow of FIG. 7 may also support continuous lifecycle management. A model trained using simulation data may be recalibrated using data from a hydraulic test facility. The recalibrated model may be refined using engineering-scale or mock-system testing. An engineering testbed may comprise a mock microreactor core, a coolant system, a power conversion system, a radiation containment system, a hydraulic test system, or combinations thereof. Sensors integrated with the engineering testbed may include neutron flux sensors, radiation sensors, temperature sensors, pressure sensors, and position sensors. The refined model may thereafter be coupled to a deployed reactor for real-time or near-real-time monitoring and control support. According to various aspects, the framework may support design-time analysis during initial system development. The framework may facilitate commissioning activities when a reactor is brought into service. Operator training may be supported through simulation-based exercises using the digital twin. Anomaly detection capabilities may identify deviations from expected operating behavior. Predictive maintenance functions may anticipate component degradation or failure. Licensing support may be provided through documentation and analysis capabilities. In-service optimization may improve reactor performance over the operational lifetime. One or more blocks within the framework may be omitted, combined, or reordered depending on the implementation. The framework may be supplemented with additional tools such as model-governance software, cybersecurity features, data-quality filters, uncertainty quantification modules, or human-factors interfaces.

High-fidelity simulation tools such as OpenMC may produce highly accurate physics outputs, including detailed neutron flux distributions and reaction rates, but may require computational times that are too long for real-time or near-real-time use. To address this limitation, such tools may be run offline across a range of microreactor parameters to generate training data for machine-learning surrogates. For example, OpenMC may be executed for various control rod positions, coolant conditions, or power levels to produce a dataset associating input conditions with corresponding neutronic outputs. This dataset may then be used to train or refine machine-learning models such as neural networks or ensemble regressors. The trained surrogate models may thereafter execute rapidly enough to support online inference and control while preserving a degree of fidelity derived from the underlying high-fidelity simulations. In some embodiments, the trained surrogate models produced through this process may be implemented as, or incorporated into, the digital twin microreactor model 522 of FIG. 8 for use in real-time or near-real-time monitoring and control.

FIG. 8 illustrates an exemplary operational-control architecture for a microreactor system. The architecture includes a digital twin microreactor model 522, which is a computational representation of the physical microreactor system. The digital twin microreactor model 522 shown in FIG. 8 may be developed, trained, validated, and refined within the digital twin framework of FIG. 7, may be implemented using the model architecture of FIG. 9, and may be operated according to the control-update process of FIG. 10. In this manner, FIG. 7 describes lifecycle development of the model, FIG. 9 describes exemplary internal model structure, FIG. 8 describes deployment of the model in a reactor-control architecture, and FIG. 10 describes iterative updating of the control action during operation. The digital twin microreactor model 522 may include an artificial intelligence or machine learning component. The digital twin microreactor model 522 serves as a virtual counterpart for the purpose of simulation, prediction, monitoring, and control. In operation, operational data generated by the physical microreactor system 528 are acquired at an acquisition block 520. Acquisition block 520 may include one or more data acquisition processors configured to receive and process the operational data. The operational data can include sensor outputs 550, which may include neutron flux, temperature, pressure, radiation, control rod position, steam production, and steam flow data. The acquisition block 520 also receives updated operational data 529 from the operation interface 530. The acquisition block 520 supplies data to the digital twin microreactor model 522. Using the operational data, the digital twin microreactor model 522 may generate a control output 524. The control output 524 is applied through an actuation mechanism 526 to adjust the physical microreactor system 528. The physical microreactor system 528 may correspond to the same reactor installation from which the operational data and updated operational data 529 are obtained. Updated operational data 529 are returned to support continued control refinement. In some embodiments, the operational data supplied to the digital twin microreactor model 522 correspond to measured states of physical reactor subsystems, including neutron flux, control rod position, coolant temperature, coolant pressure, pump state, valve position, steam-production conditions, and feedwater conditions, and the control output 524 corresponds to a command for one or more physical actuators of the reactor system. For example, the control output 524 may command a control-rod drive mechanism, a primary-coolant pump controller, a valve actuator, a pressurizer heater, a pressurizer spray assembly, a gas circulator or blower, or a feedwater pump, depending on the reactor configuration. For a deployed reactor installation, the digital twin microreactor model 522 may be parameterized using design data, test data, and initial operational data from the physical microreactor system 528 and may thereafter be recalibrated using updated operational data 529. The architecture may also include an operation interface 530 through which plant conditions or recommended actions are presented. Operational constraints 540 govern permissible control behavior. The operational constraints 540 may include safety thresholds, licensing requirements, output-power targets, efficiency objectives, thermal limits, or combinations thereof.

In embodiments where the nuclear reactor system comprises a gas-cooled pebble bed reactor, such as the nuclear reactor system 400 described with reference to FIG. 5, operational data indicative of fuel pebble distribution or accumulation may be supplied to the acquisition block 520 and the digital twin microreactor model 522. The pebble-related operational data may include radiation signatures, neutron flux distribution, temperature gradients, acoustic signals, pressure drop across the pebble bed, flow characteristics, or other sensor outputs associated with the fuel pebble monitoring features described above. The digital twin microreactor model 522 may compare detected conditions with expected or modeled states to determine whether corrective action is warranted. Based on that comparison, the digital twin microreactor model 522 may generate a control output 524 that adjusts control rod position, gas flow rate, gas circulator or blower operating state, valve position, or another gas-flow-control device state. The control output 524 may then be implemented through the actuation mechanism 526 to adjust the physical microreactor system 528. Updated operational data 529 may be returned to support continued monitoring and control refinement.

The operation interface 530 may present current conditions, predicted conditions, constraints, confidence values, recommended actions, or alarm states to an operator. The operation interface 530 may correspond to or communicate with the user interfaces described elsewhere herein. In some implementations, the operation interface 530 supports fully automated control. In other implementations, the operation interface 530 supports supervisory approval, operator confirmation, or manual override. The architecture of FIG. 8 may be configured as an advisory overlay on an existing plant control system, as a supervisory control layer, or as a primary control architecture. One or more components of the architecture may be integrated, distributed, duplicated for redundancy, or selectively omitted.

FIG. 9 illustrates an exemplary model architecture that may be used in connection with a digital twin framework for nuclear reactor control. The model architecture supports physics-based modeling and machine-learning techniques that may be used separately or in combination to generate control-relevant outputs. In some embodiments, one or more components of the model architecture of FIG. 9, including the reduced-order or physics-based model, the machine-learning surrogate framework, and the output or fusion block, collectively implement all or part of the digital twin microreactor model 522 of FIG. 8.

The model architecture includes a reduced-order or physics-based model 600 and a simplified physics-based model 610. The reduced-order or physics-based model 600 and the simplified physics-based model 610 may supply state information, features, constraints, or baseline predictions to a machine-learning surrogate framework 620. The machine-learning surrogate framework 620 may include one or more machine-learning surrogate models. The machine-learning surrogate models may include a neural network 622, a regression model 624, and an ensemble regressor 626. The machine-learning surrogate models may operate individually or together as part of a data-driven machine-learning model 628. An output or fusion block 629 may combine or select among the resulting model outputs to produce a predicted or otherwise control-relevant quantity. Simulated or ROM performance data 630 may support training and model development throughout the architecture.

The arrangement of FIG. 9 is intended to be flexible. The model architecture may support fully physics-based, hybrid, or purely data-driven implementations. For example, one implementation may omit the data-driven machine-learning model 628 and rely primarily on the reduced-order or physics-based model 600. Another implementation may omit one or more of the individual surrogate types within the machine-learning surrogate framework 620. Another implementation may use the simplified physics-based model 610 only during training while relying on the data-driven machine-learning model 628 during deployment. The predicted or control-relevant output generated through the output or fusion block 629 may include a projected reactor state, a control output, an estimated constraint margin, an anomaly score, or a recommended setpoint. The model architecture may be deployed on a single computing device or across distributed computing resources.

In some embodiments, one or more of the reduced-order or physics-based model 600, the simplified physics-based model 610, the machine-learning surrogate framework 620, the data-driven machine-learning model 628, and the output or fusion block 629 collectively implement all or part of the digital twin microreactor model 522 of FIG. 8.

FIG. 10 illustrates an exemplary control-update flow that can be used with the control system of FIG. 8. The process operates as a continuous or near-real-time update loop for reactor control. In some embodiments, the control-update flow includes receiving operational data, determining a current reactor state 710, generating a projected reactor state 712 using the digital twin microreactor model 522, and producing or revising a control output 524 for implementation through the actuation mechanism 526 of FIG. 8.

The process includes a current reactor state 710. The current reactor state 710 represents the present operating conditions of the reactor system. The current reactor state 710 is used to produce a projected reactor state 712. The projected reactor state 712 represents anticipated future operating conditions. The current reactor state 710 also informs a feedback control block 714. The feedback control block 714 monitors deviations between observed and desired operating states. A predictive control block 716 anticipates future system behavior and constraint interactions. Both the feedback control block 714 and the predictive control block 716 provide inputs to an adjustment or update block 718. The adjustment or update block 718 revises the control action based on the combined feedback and predictive information. Through this arrangement, the system can compare present conditions with anticipated future behavior. In some embodiments, the current reactor state 710 is determined from the operational data and updated operational data 529 of FIG. 8, the projected reactor state 712 is generated using the digital twin microreactor model 522 of FIG. 8, and the adjustment or update block 718 produces or revises the control output 524 for implementation through the actuation mechanism 526 of FIG. 8.

The flow of FIG. 10 may be executed at fixed intervals, variable intervals, or event-triggered intervals. The loop may be implemented with a receding-horizon strategy, a state-estimation strategy, a rule-based strategy, or a hybrid strategy. The projected reactor state 712 may be provided to the adjustment or update block 718 directly or through one or more supervisory filters. The resulting update may be applied automatically or presented for operator review before implementation. Multiple projected states, multiple feedback channels, or multiple predictive controllers may be used in parallel. Safety filters, licensing constraints, and human-authorization requirements may be incorporated at any stage of the loop.

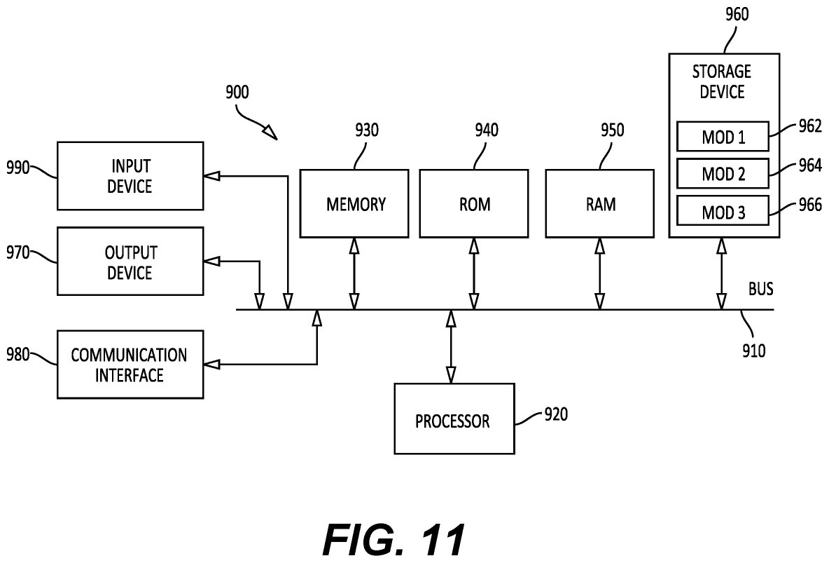

With reference to FIG. 11, an exemplary system includes a computing device 900 (such as a general-purpose computing device), including a processing unit (CPU or processor) 920 and a system bus 910 that couples various system components including the system memory 930 such as read-only memory (ROM) 940 and random access memory (RAM) 950 to the processor 920. The computing device 900 can include a cache of high-speed memory connected directly with, in close proximity to, or integrated as part of the processor 920. The computing device 900 copies data from the system memory 930 and/or the storage device 960 to the cache for quick access by the processor 920. In this way, the cache provides a performance boost that avoids processor 920 delays while waiting for data. These and other modules can control or be configured to control the processor 920 to perform various actions. Other system memory 930 may be available for use as well. The system memory 930 can include multiple different types of memory with different performance characteristics. It can be appreciated that the disclosure may operate on a computing device 900 with more than one processor 920 or on a group or cluster of computing devices networked together to provide greater processing capability. The processor 920 can include any processor and a hardware module or software module, such as a first module 962, a second module 964, and a third module 966 stored in storage device 960, configured to control the processor 920 as well as a special-purpose processor where software instructions are incorporated into the actual processor design. The digital twin microreactor model 522, the reduced-order model 600, the machine-learning surrogate models 622, 624, and 626, and the data-driven machine-learning model 628 are examples of modules. The processor 920 may essentially be a completely self-contained computing system, containing multiple cores or processors, a bus, memory controller, cache, etc. A multi-core processor may be symmetric or asymmetric.

The system bus 910 may be any of several types of bus structures including a memory bus or memory controller, a peripheral bus, and a local bus using any of a variety of bus architectures. A basic input/output (BIOS) stored in ROM 940 or the like, may provide the basic routine that helps to transfer information between elements within the computing device 900, such as during start-up. The computing device 900 further includes storage devices 960 such as a hard disk drive, a magnetic disk drive, an optical disk drive, tape drive or the like. The storage device 960 can include software modules 962, 964, and 966 for controlling the processor 920. Other hardware or software modules are contemplated. The storage device 960 is connected to the system bus 910 by a drive interface. The drives and the associated computer-readable storage media provide nonvolatile storage of computer-readable instructions, data structures, program modules and other data for the computing device 900. In one aspect, a hardware module that performs a particular function includes the software component stored in a tangible computer-readable storage medium in connection with the necessary hardware components, such as the processor 920, system bus 910, output device 970, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 900 is a small, handheld computing device, a desktop computer, or a computer server.

Although the exemplary embodiment described herein employs a hard disk as the storage device 960, other types of computer-readable media which can store data that are accessible by a computer, such as magnetic cassettes, flash memory cards, digital versatile disks, cartridges, random access memories (RAMs) 950, and read-only memory (ROM) 940, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 900, an input device 990 represents any number of input mechanisms, such as a microphone for speech, a touch-sensitive screen for gesture or graphical input, keyboard, mouse, motion input, speech and so forth. An output device 970 can also be one or more of a number of output devices including printers and displays. In some instances, multimodal systems enable a user to provide multiple types of input to communicate with the computing device 900. The communications interface 980 generally governs and manages the user input and system output. There is no restriction on operating on any particular hardware arrangement and therefore the basic features here may easily be substituted for improved hardware or firmware arrangements as they are developed.

The computing device 900 may be described in the general context of computer system-executable instructions, such as program modules, being executed by a computer system. Generally, program modules may include routines, programs, objects, components, logic, data structures, and so on that perform particular tasks or implement particular abstract data types. In configurations where the computing device 900 is used in a distributed cloud computing environment (such as where the computing device 900 utilizes one or more servers) where tasks are performed by remote processing devices that are linked through a communications network. In a distributed cloud computing environment, program modules may be located in both local and remote computer system storage media including memory storage devices.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Neural networks, foundational to modern artificial intelligence, are computational systems designed to process data and generate predictions or classifications by emulating aspects of human brain function. A neural network is a framework of machine learning algorithms that work together to classify inputs based on a previous training process. They power applications like image recognition, natural language processing, and predictive analytics. At their core, neural networks consist of interconnected layers of mathematical units called neurons, organized into an input layer, one or more hidden layers, and an output layer. The input layer receives raw or preprocessed data, such as pixel values or text embeddings, represented as numerical vectors. Hidden layers transform this data into increasingly abstract representations through complex computations, while the output layer produces the result, such as a class probability or a numerical prediction. Each neuron connects to those in the next layer via weighted connections, where weights are numerical values that amplify or diminish the influence of one neuron's output on another's input. Additionally, biases—adjustable offsets—enhance the model's flexibility in fitting data.

The operation of a neural network begins with a forward pass, where data flows from the input layer through the hidden layers to the output. Each neuron computes a weighted sum of its inputs, adds its bias, and applies a nonlinear activation function, such as a sigmoid, rectified linear unit (ReLU), or hyperbolic tangent (tanh), to produce an output. This process repeats across layers, with each layer extracting more complex features, such as edges in images or semantic patterns in text. The final layer's output depends on the task: classification tasks yield probabilities (e.g., “90%”), while regression tasks produce continuous values (e.g., a predicted temperature). Crucially, the forward pass does not alter the model's stored parameters—weights and biases—which represent the network's learned knowledge. These parameters are stored in digital memory, typically as 32-bit or 16-bit floating-point arrays. Weights form matrices, with rows and columns corresponding to neurons in adjacent layers, while biases are stored as one-dimensional arrays. Meta-information, such as layer counts and activation function types, is also stored to define the network's structure.

Training a neural network involves adjusting its parameters to minimize prediction errors. During training, a forward pass generates predictions, which are compared to correct outputs using a loss function, such as mean squared error or cross-entropy, to quantify errors. Backpropagation then computes gradients, indicating how much each parameter contributed to the error, by applying the chain rule to propagate errors backward from the output to the input layer. Optimization algorithms, like stochastic gradient descent, adjust weights and biases in directions that reduce the loss. This process iterates over multiple epochs, with parameters gradually converging to values that improve accuracy. Memory usage during training is dynamic: weights and biases are updated incrementally for each data batch, and intermediate results, like neuron activations and gradients, are temporarily stored in buffers to facilitate backpropagation. To ensure progress is saved, parameters are periodically checkpointed to persistent storage, allowing training to resume later. Efficiency techniques, such as reducing parameter precision to 16-bit formats, further optimize memory and computation.

Once trained, the network enters inference mode, where parameters are fixed, and only forward passes are executed to generate predictions. This mode minimizes memory writes, making it ideal for deployment on resource-constrained devices like mobile phones. Neural networks can reduce memory usage, use unique parameter update mechanisms to enhance training efficiency, use hybrid memory systems combining volatile and non-volatile storage, and/or perform dynamic precision adjustments during training or inference.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Further aspects of the present disclosure are provided by the subject matter of the following clauses.

In some embodiments, a method for controlling operation of a nuclear reactor system comprises: receiving operational data for the nuclear reactor system, the operational data being indicative of an operating state of the nuclear reactor system; processing the operational data using a digital twin nuclear reactor model to generate a control output for at least one control parameter of the nuclear reactor system; and causing adjustment of the at least one control parameter based on the control output.

The method of any preceding clause, wherein the operational data comprises one or more of neutron flux data, temperature data indicative of temperature in a reactor core region, temperature data indicative of temperature within a coolant system of the nuclear reactor system, pressure data indicative of pressure within the coolant system of the nuclear reactor system, radiation data, steam production data, and control rod position data.

The method of any preceding clause, wherein the digital twin nuclear reactor model includes a reduced-order model (ROM) or a simplified physics-based model.

The method of any preceding clause, wherein the digital twin nuclear reactor model comprises a hybrid model including (i) a reduced-order physics-based model and (ii) a machine-learning surrogate.

The method of any preceding clause, wherein the digital twin nuclear reactor model comprises a data-driven machine-learning model trained using nuclear reactor system performance data.

The method of any preceding clause, wherein the digital twin nuclear reactor model comprises a neural network or a regression model, including an ensemble regressor.

The method of any preceding clause, wherein generating the control output comprises performing predictive control, feedback control, or both.

In some embodiments, a system for controlling operation of a nuclear reactor system comprises: at least one sensor configured to provide operational data for the nuclear reactor system, the operational data being indicative of an operating state of the nuclear reactor system; one or more processors; a memory storing instructions that, when executed, cause the one or more processors to process the operational data using a digital twin nuclear reactor model to generate a control output for at least one control parameter of the nuclear reactor system; and at least one actuation mechanism configured to implement the control output by adjusting the at least one control parameter.

The system of any preceding clause, wherein the at least one sensor comprises one or more of: a neutron flux sensor; a temperature sensor positioned to monitor a reactor core region of the nuclear reactor system or a coolant system of the nuclear reactor system; a pressure sensor positioned to monitor pressure within the coolant system of the nuclear reactor system; a radiation sensor; and a control rod position sensor.

The system of any preceding clause, wherein the at least one control parameter comprises one or more of: control rod position; primary-coolant pump operating state; and coolant flow-control device state.

The system of any preceding clause, wherein the instructions, when executed, cause the one or more processors to generate the control output to satisfy at least one operational constraint comprising a safety threshold, a licensing requirement, an output-power target, an efficiency objective, or a thermal limit.

The system of any preceding clause, wherein the digital twin nuclear reactor model comprises a hybrid model including (i) a reduced-order physics-based model and (ii) a machine-learning surrogate.

The system of any preceding clause, wherein the instructions, when executed, further cause the one or more processors to update the control output in real time or near real time in response to updated operational data.

The system of any preceding clause, wherein the instructions, when executed, further cause the one or more processors to generate the control output using predictive control, feedback control, or both.

In some embodiments, a non-transitory computer-readable medium stores instructions that, when executed by one or more processors, cause the one or more processors to: receive operational data for a nuclear reactor system, the operational data being indicative of an operating state of the nuclear reactor system; process the operational data using a digital twin nuclear reactor model to generate a control output for at least one control parameter of the nuclear reactor system; and cause adjustment of the at least one control parameter based on the control output.

The non-transitory computer-readable medium of any preceding clause, wherein the digital twin nuclear reactor model is trained using data generated by a reduced-order model (ROM).

The non-transitory computer-readable medium of any preceding clause, wherein the digital twin nuclear reactor model comprises a data-driven machine-learning model trained using simulated nuclear reactor system performance data.

The non-transitory computer-readable medium of any preceding clause, wherein the digital twin nuclear reactor model comprises a neural network or a regression model, including an ensemble regressor.

The non-transitory computer-readable medium of any preceding clause, wherein the instructions, when executed, further cause the one or more processors to generate the control output to adjust at least one of control rod position, primary-coolant pump operating state, or coolant flow-control device state.

The non-transitory computer-readable medium of any preceding clause, wherein the instructions, when executed, further cause the one or more processors to generate the control output in real time or near real time to satisfy at least one operational constraint comprising a safety threshold, a licensing requirement, an output-power target, an efficiency objective, or a thermal limit.

In any of the above embodiments, the instructions, when executed, further cause the one or more processors to generate the control output in real time or near real time to satisfy at least one operational constraint comprising a safety threshold, a licensing requirement, an output-power target, an efficiency objective, or a thermal limit.

Although this invention has been described with respect to certain specific exemplary embodiments, various modifications, adaptations, and alternatives will be apparent to those skilled in the art in light of this disclosure. It is, therefore, to be understood that this invention may be practiced otherwise than as specifically described. Thus, the exemplary embodiments of the invention should be considered in all respects to be illustrative and not restrictive, and the scope of the invention is determined by any claims supportable by this disclosure and the equivalents of the embodiments and structures discussed herein, rather than by the foregoing description.

1. A computer-implemented method for controlling operation of a nuclear reactor system, the method comprising:
receiving, by one or more processors, operational data for the nuclear reactor system, the operational data being indicative of an operating state of the nuclear reactor system;
processing, by the one or more processors, the operational data using a digital twin nuclear reactor model to generate a control output for at least one control parameter of the nuclear reactor system; and
causing adjustment of the at least one control parameter based on the control output.

2. The computer-implemented method of claim 1, wherein the operational data comprises one or more of neutron flux data, temperature data indicative of temperature in a reactor core region, temperature data indicative of temperature within a coolant system of the nuclear reactor system, pressure data indicative of pressure within the coolant system of the nuclear reactor system, radiation data, steam production data, and control rod position data.

3. The computer-implemented method of claim 1, wherein the digital twin nuclear reactor model includes a reduced-order model (ROM) or a simplified physics-based model.

4. The computer-implemented method of claim 1, wherein the digital twin nuclear reactor model comprises a hybrid model including (i) a reduced-order physics-based model and (ii) a machine-learning surrogate.

5. The computer-implemented method of claim 1, wherein the digital twin nuclear reactor model comprises a data-driven machine-learning model trained using nuclear reactor system performance data.

6. The computer-implemented method of claim 1, wherein the digital twin nuclear reactor model comprises a neural network or a regression model, including an ensemble regressor.

7. The computer-implemented method of claim 1, wherein generating the control output comprises performing predictive control, feedback control, or both.

8. A system for controlling operation of a nuclear reactor system, the system comprising:
at least one sensor configured to provide operational data for the nuclear reactor system, the operational data being indicative of an operating state of the nuclear reactor system;
one or more processors;
a memory storing instructions that, when executed by the one or more processors, cause the one or more processors to process the operational data using a digital twin nuclear reactor model to generate a control output for at least one control parameter of the nuclear reactor system; and
at least one actuation mechanism configured to implement the control output by adjusting the at least one control parameter of the nuclear reactor system.

9. The system of claim 8, wherein the at least one sensor comprises one or more of: a neutron flux sensor; a temperature sensor positioned to monitor a reactor core region of the nuclear reactor system or a coolant system of the nuclear reactor system; a pressure sensor positioned to monitor pressure within the coolant system of the nuclear reactor system; a radiation sensor; and a control rod position sensor.

10. The system of claim 8, wherein the at least one control parameter comprises one or more of: control rod position; primary-coolant pump operating state; and coolant flow-control device state.

11. The system of claim 8, wherein the instructions, when executed, further cause the one or more processors to generate the control output to satisfy at least one operational constraint comprising a safety threshold, a licensing requirement, an output-power target, an efficiency objective, or a thermal limit.

12. The system of claim 8, wherein the digital twin nuclear reactor model comprises a hybrid model including (i) a reduced-order physics-based model and (ii) a machine-learning surrogate.

13. The system of claim 8, wherein the instructions, when executed, further cause the one or more processors to update the control output in real time or near real time in response to updated operational data.

14. The system of claim 8, wherein the instructions, when executed, further cause the one or more processors to generate the control output using predictive control, feedback control, or both.

15. A non-transitory computer-readable medium storing instructions that, when executed by one or more processors, cause the one or more processors to:
receive operational data for a nuclear reactor system, the operational data being indicative of an operating state of the nuclear reactor system;
process the operational data using a digital twin nuclear reactor model to generate a control output for at least one control parameter of the nuclear reactor system; and
cause adjustment of the at least one control parameter based on the control output.

16. The non-transitory computer-readable medium of claim 15, wherein the digital twin nuclear reactor model is trained using data generated by a reduced-order model (ROM).

17. The non-transitory computer-readable medium of claim 15, wherein the digital twin nuclear reactor model comprises a data-driven machine-learning model trained using simulated nuclear reactor system performance data.

18. The non-transitory computer-readable medium of claim 15, wherein the digital twin nuclear reactor model comprises a neural network or a regression model, including an ensemble regressor.

19. The non-transitory computer-readable medium of claim 15, wherein the instructions, when executed, further cause the one or more processors to generate the control output to adjust at least one of control rod position, primary-coolant pump operating state, or coolant flow-control device state.

20. The non-transitory computer-readable medium of claim 15, wherein the instructions, when executed, further cause the one or more processors to generate the control output in real time or near real time to satisfy at least one operational constraint comprising a safety threshold, a licensing requirement, an output-power target, an efficiency objective, or a thermal limit.
